(19) United States
(12) Patent Application Publication
(10) Pub. No.: US 2006/0013922 A1
(43) Pub. Date: Jan. 19, 2006

(54) Cookie product

(76) Inventor: Ashok V. Chandaria, Nairobi (KE)

Correspondence Address: SAND & SEBOLT, AEGIS TOWER, SUITE 1100, 4940 MUNSON STREET, NW, CANTON, OH, 44718-3615, US

(21) Appl. No.: 10/890,429

(22) Filed: Jul. 13, 2004

(51) Int. Cl. A22C 13/00

(52) U.S. Cl. 426/87

(57) ABSTRACT

A laminated cookie product having a pair of outer layers which are more liquid absorbent than an inner layer when dunked in a liquid. The inner layer maintains the shape and integrity of the cookie as the outer layer absorbs more of the liquid. A plurality of indicia is provided on the cookie including a plurality of spaced line which indicates the length of the cookie immersed in a liquid and/or the amount of calories contained in the cookie between a selected indicia line and the bottom of the cookie. Aligned recesses are formed in an upper end of the cookie to facilitate gripping the cookie for dunking in a liquid.

### BACKGROUND OF THE INVENTION

1. Technical Field

The invention relates to bakery products, and in particular to a cookie having a more liquid absorbent outer portion and a more rigid inner portion to maintain the integrity of the cookie when it is being dunked into a liquid. The invention furthermore pertains to a cookie having indicia provided thereon, which indicates the depth that the cookie is dunked into a liquid and/or the amount of calories throughout the length of the cookie.

2. Background Information

Children as well as adults enjoy dunking a food product, such as a cookie, in a liquid such as milk, coffee, tea, etc. which will absorb some of the liquid and soften the texture of the cookie to make it more palatably pleasing. However, one problem that occurs when the cookie is dunked into a liquid is if the cookie is made of a dough which is highly absorbent to the liquid, the liquid quickly saturates the cookie whereupon it crumbles and breaks before the cookie can be eaten. If the cookie is made of a dough which is less susceptible to liquid absorbency, it does not reach the softness and texture desired by many people.

This difficulty with the cookie being too absorbent is recognized and discussed in U.S. Pat. No. 4,773,132, which discloses a mechanism for holding the cookie to assist in retaining stability to prevent it from crumbling when dunked into a liquid.

Although the cookie can be made less absorbent to liquid, it does not provide the flavor and texture desired by many people. Children especially enjoy dunking a cookie into a liquid, either completely or at various depths, hoping that the cookie does not crumble prematurely, while enjoying a large amount of the cookie in a single dunk.

Many people today are concerned with weight gain and weight loss, and although the calorie content of most cookies is set forth on the package in which the cookies are purchased, it only reflects the calories for the entire cookie. Thus, this requires the user to either break the cookie into sections and calculate the calories contained therein, or in most cases will result in the entire cookie being eaten by the consumer.

Therefore, the need exists for a cookie product which provides a desired texture that is usually achieved by use of a dough which absorbs a relatively large quantity of a liquid into which it is dunked without crumbling, making it difficult to dunk and eat without creating a mess.

Another need exists for a cookie which can be enjoyed by children which indicates the depth of the dunk, and provides adults an accurate calorie content of that portion of the cookie being eaten.

### BRIEF SUMMARY OF THE INVENTION

One aspect of the present invention is to provide a cookie product which is a laminated dough body formed with inner and outer layers of dough having a greater liquid absorbency than an inner layer which is more resistant to absorbing liquid, thereby providing the desired rigidity to the cookie while enabling the more palatable and desirable cookie dough to be used as outer layers of the cookie.

Another feature of the invention is to provide a cookie having indicia, preferably embedded into or embossed on the outer surfaces of the cookie, which indicia provides graduations indicating the depth in which the cookie can be dunked into a liquid, thereby providing enjoyment and novelty aspects for children.

Still another feature of the present invention is to provide the cookie with indicia on at least one of the surfaces of the cookie which indicates the amount of calories that various portions of the cookie contains, thereby enabling a weight conscience person to more accurately determine how many calories are consumed if only portions of the cookie is eaten.

A further aspect of the present invention is to provide a cookie having a unique shape, with a parallelopiped lower main body portion and a generally rounded top body portion which is formed with aligned recesses to provide an area for gripping the cookie, especially when it is being dunked into a liquid.

These objectives and advantages are obtained by the cookie product of the present invention, the general nature of which may be stated as including first and second outer layers of dough having a certain rate of liquid absorbency, and an intermediate layer of a dough sandwiched between said first and second outer layers, wherein the intermediate layer has a lower rate of liquid absorbency than said outer first and second layers.

These features and advantages are further obtained by the cookie product of the present invention, the general nature of which may be stated as including a body formed of a dough suitable for dunking in a liquid, wherein the body has a pair of generally opposed surfaces and an end, and a plurality of spaced indicia on one or both of said opposed surfaces, which specify specific lengths of the cookie for indicating calorie content or depth of dunk.

### BRIEF DESCRIPTION OF THE DRAWINGS

A preferred embodiment of the invention, illustrative of the best mode in which applicant contemplates applying the principles, is set forth in the following description and is shown in the drawings and is particularly and distinctly pointed out and set forth in the appended claims.

FIG. 1 is a side elevational view of the cookie product of the present invention;

FIG. 2 is a sectional view taken along lines 2-2, FIG. 1;

FIG. 3 is a diagrammatic view with portions in section showing the cookie of FIGS. 1 and 2 being dunked into a liquid; and

FIG. 4 is a side elevational view of a cookie having printed indicia thereon, indicating the calorie content of various sections of the cookie.

Similar numerals refer to similar parts throughout the drawings.

### DETAILED DESCRIPTION OF THE INVENTION

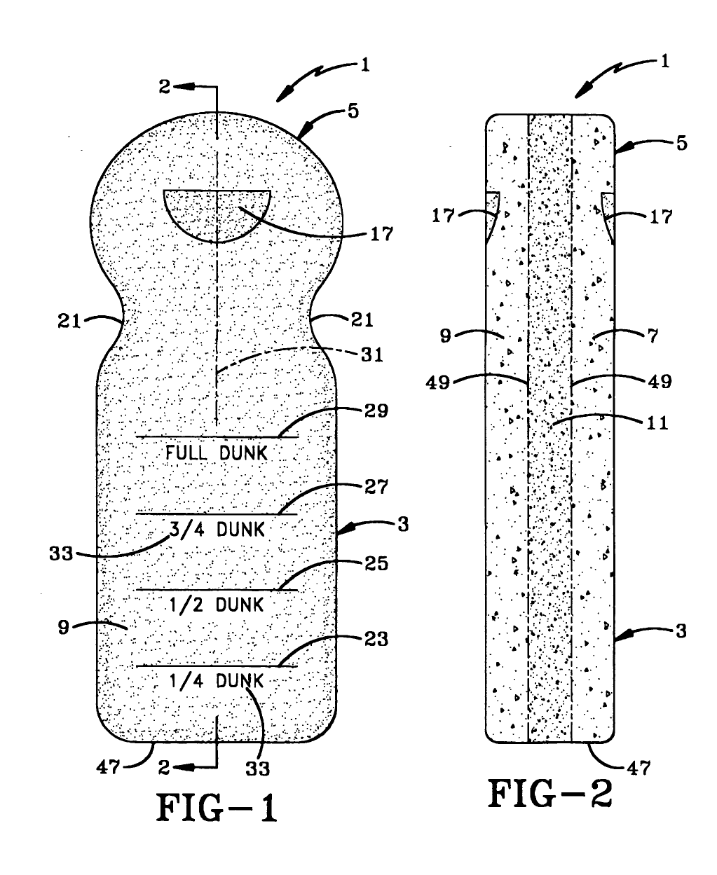

The cookie of the present invention is indicated generally at 1, and is shown particularly in FIGS. 1 and 2. Cookie 1 includes a generally parallelopiped rectangular-shaped lower body 3, and a generally circular rounded upper portion 5.

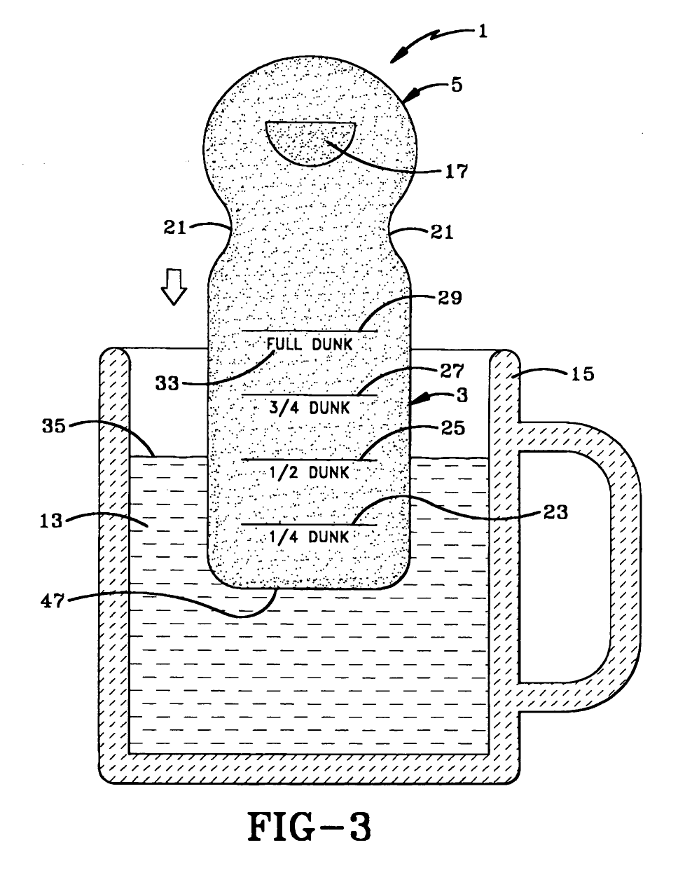

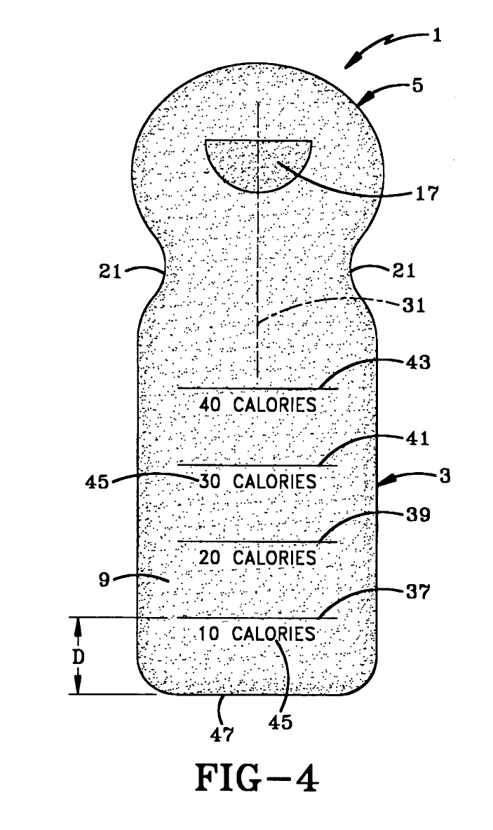

As shown in FIG. 2, cookie 1 is of a laminated construction having outer layers 7 and 9 and an inner layer 11. One, and preferably both outer layers 7 and 9 are formed of dough which is more liquid absorbent than inner layer 11. This is achieved by changing the consistency of the dough, such as described in U.S. Pat. No. 4,588,596, and which is well known in the bakery art. Thus with this construction, when the cookie is dunked into a liquid 13, such as shown in FIG. 3, contained with a cup 15, inner dough layer 11 prevents the cookie from crumbling due to the reduced strength of outer layers 7 and 9 because of the liquid being quickly absorbed into outer layers 7 and 9. Heretofore, a cookie of a single consistency would crumble relatively quickly, especially if it is of a highly absorbent dough, which is desired for many cookies due to the pleasing taste and texture provided by the more absorbent cookie dough.

Another feature of cookie 1 is that the rounded upper body portion 5 is provided with a pair of aligned recesses 17, which provide finger areas which are easily gripped when dunking the cookie into a liquid. Upper body 5 may be joined to rectangular-shaped lower body 3 by a pair of concave areas 21. However, the entire cookie could have various shapes than that shown and described above without affecting the main concept and features of the invention.

In accordance with another feature of the invention, a plurality of indicia, such as a plurality of spaced straight lines 23, 25, 27, and 29, are formed in a generally horizontal direction across lower body portion 3 generally transverse to the longitudinal axis 31 of the cookie. Indicia lines 23-29 preferably will be slightly embedded into the dough or embossed thereon, or both, and include printed indicated at 33. Indicia 33 indicates the distance for dunking the cookie into liquid 13 which would be enjoyable, especially for children. For example, indicia line 23 represents ¼ of the cookie body. When liquid level 3 reaches line 25 as shown in FIG. 3, it indicates that ½ of the cookie lower body has been dunked into the liquid and so forth for indicia lines 27 and 29.

In a modified embodiment of cookie 1 (FIG. 4), indicia in the form of spaced parallel lines 37, 39, 41, and 43 extend horizontally across lower body portion 3 generally transverse to longitudinal axis 31 in a similar manner as indicia lines 23-29. Printed indicia, as indicated at 45, is embedded or embossed on the outer surface or surfaces of layers 7 and 9, and indicates the amount of calories which are contained in the cookie extending from the bottom end 47 thereof up to the appropriate indicia line 37, 39, etc. For example, if the lower part of the cookie indicated by distance arrow D (FIG. 4) was consumed, it would be 10 calories. Thus, an individual, and in particular a weight conscience adult, could accurately measure the calorie content he or she is consuming by severing the cookie along one of the indicia lines 37-43, or just eating from end 47 to the selected indicia line.

If preferred, one side of the cookie could have the depth of dunk indicating lines as shown in FIGS. 1 and 3, and the other side having the calorie content indicia lines 37-43 thereon, as shown in FIG. 4.

Intermediate cookie layer 11 also could be made less liquid absorbent by coating layer 11 with a type of coating 49, which could be an edible fatty acid salt such as described in U.S. Pat. No. 4,588,596 or other of component, well known in the bakery art, instead of incorporating other additives directly into the dough as an ingredient thereof. Thus, either by changing the consistency of intermediate dough layer 11 or coating it with a liquid resistant coating, it provides a laminated cookie whereby inner layer 11 maintains the stability of the cookie while the outer layers absorb a desired amount of liquid, making the texture and taste more pleasurable than if the entire cookie was formed of the generally harder, less absorbent dough as is intermediate layer 11.

As shown in FIG. 2, preferably outer layers 7 and 9 will have the same thickness which may also be equal to or differ from intermediate dough layer 11. Likewise, the layers preferably are complementary in shape and size as shown in FIGS. 1 and 2, although the dimension, thickness, and heights thereof could vary without affecting the main concept of the invention. The particular consistency of the dough forming layers 7, 9, and 11 can vary appreciably and can be of the type used for various types of cookies, such as chocolate chip, oatmeal raisin, ginger snaps, etc., with the consistency being modified by one skilled in the bakery art to provide the desired difference in liquid absorbency between outer layers 7 and 9 and intermediate layer 11.

Furthermore, the use of indicia embedded, embossed, or printed on the outer surfaces, especially in a plurality of spaced lines provide an indication of the depth that the cookie is dunked into a liquid and/or the amount of calories contained in various segments of the cookie lower body.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A cookie product comprising:
first and second outer layers of a dough having a certain rate of liquid absorbency; and
an intermediate layer of a dough sandwiched between said first and second outer layers, said intermediate layer having a lower rate of liquid absorbency than said outer first and second layers.

2. The cookie product defined in claim 1 wherein the first and second outer layers and intermediate layer are complementary in shape and size.

3. The cookie product defined in claim 1 wherein aligned recesses are formed in the first and second outer layers.

4. The cookie product defined in claim 1 wherein the first and second outer layers each have an outer surface; and in which indicia is contained on at least one of the outer surfaces.

5. The cookie product defined in claim 4 wherein the indicia is a series of spaced lines extending generally transverse to a longitudinal axis of the cookie providing an indication of the distances from a bottom end of the cookie to provide the depth that the cookie is inserted into a dunking liquid.

6. The cookie product defined in claim 4 wherein the indicia is a series of spaced lines extending generally transverse to a longitudinal axis of the cookie providing an indication as to the amount of calories contained in that portion of the cookie extending between a selected one of the spaced lines and a bottom end of the cookie.

7. The cookie product defined in claim 1 wherein the cookie has a generally rectangular parallelepiped shaped main body portion for dunking into a liquid and a generally rounded upper body portion connected to the main body portion by concave areas.

8. The cookie product defined in claim 7 wherein recesses are formed in the rounded upper body portion to provide a gripping area when dunking the cookie in a liquid.

9. The cookie product defined in claim 1 wherein the first and second outer layers and intermediate layer are generally equal in thickness.

10. The cookie product defined in claim 1 wherein the first and second outer layers are formed of a dough less dense than the dough forming the intermediate layer.

11. The cookie product defined in claim 1 wherein the intermediate dough layer is coated with a liquid repellent material to provide the lower rate of liquid absorbency.

12. A cookie product comprising:
a body formed of a dough suitable for dunking in a liquid, said body having a pair of generally opposed outer surfaces and an end; and
a plurality of spaced indicia on at least one of said opposed outer surfaces, said indicia specifying individual specific lengths of the cookie.

13. The cookie defined in claim 12 wherein the cookie body includes a generally rectangular shaped lower portion containing the spaced indicia; and in which the indicia is a plurality of spaced lines extending generally transverse to a longitudinal axis of the body.

14. The cookie defined in claim 13 wherein the indicia further includes markings indicating the distance of said incidia lines from the end of the cookie body.

15. The cookie defined in claim 13 wherein the indicia further includes markings indicating the amount of calories contained in the cookie body between the indicia lines and the end of the cookie body.

16. The cookie defined in claim 12 wherein the cookie body is formed as a laminated member having a pair of outer dough layers and an intermediate dough layer.

17. The cookie defined in claim 12 wherein the cookie has a generally rectangular parallelepiped shaped main body portion for dunking into a liquid and a generally rounded upper body portion integral with the main body portion by concave areas.

18. The cookie defined in claim 17 wherein recesses are formed in the rounded upper portion of the cookie body to provide a gripping area when dunking the cookie in a liquid.

19. The cookie defined in claim 16 wherein the outer dough layers and intermediate dough layer are generally equal in thickness.

20. The cookie defined in claim 16 wherein the outer layers are formed of a dough less dense than the dough forming the intermediate layer.
